(19) United States
(12) Patent Application Publication
(10) Pub. No.: US 2026/0336986 A1
(43) Pub. Date: Oct. 29, 2026

(54) A CRANE ARM ASSEMBLY AND A WORKING EQUIPMENT

(71) Applicant: Hiab AB, Malmö (SE)

(72) Inventor: Lars Elsmark, Saltsjö-Boo (SE)

(21) Appl. No.: 19/637,031

(22) Filed: Apr. 2, 2026

(30) Foreign Application Priority Data
Apr. 28, 2025 (EP) 25172884.6

(51) Int. Cl. B66C 13/06; B66C 13/22

(52) U.S. Cl. CPC B66C 13/066; B66C 13/22

(57) ABSTRACT

The disclosure relates to a crane arm assembly (100) comprising: a crane arm (101) with at least one boom (1); and at least one linear electro-mechanical actuator (50) operatively connected to the at least one boom (1) for moving the boom (1), the at least one electro-mechanical actuator (50) comprising a translation assembly (10) including a rotatable part (12) and a linearly moveable part (14) connected to each other to translate a rotating movement of the rotatable part (12) to a linear movement of the linearly movable part (14), and a drive assembly (20) arranged to provide the rotating movement of the rotatable part (12) of the translation assembly (10), the drive assembly (20) comprising an electric motor (52), wherein the crane arm assembly (100) further comprises a control system (200) configured to control the drive assembly (20), wherein the control system (200) is configured to perform an oscillation damping function based on a time-dependent variation of at least one parameter indicating a force acting on the at least one boom (1), wherein the control system (200) is configured to create a counteracting force reducing the variation of the at least one parameter, by controlling the drive assembly (20) to adjust a drive current to the electric motor (52). The disclosure further relates to a working equipment (180).

### CROSS-REFERENCE TO RELATED APPLICATIONS

This application claims priority to European Application No. 25172884.6, filed Apr. 28, 2025, the contents of which are hereby incorporated herein in its entirety by reference.

### TECHNICAL FIELD

The present disclosure relates to a crane arm assembly and a working equipment. More specifically, the disclosure relates to a crane arm assembly and a working equipment as defined in the introductory parts of the independent claims.

### BACKGROUND ART

Working equipment, such as cranes and loader cranes, are essential for lifting and moving heavy loads in various industries. However, one of the significant challenges faced by cranes is the problem of oscillations and vibrations that occur when loads are moved. These oscillations can lead to uncontrolled movements, increased wear and tear on the crane components, and potential safety hazards. Oscillations in crane systems are primarily caused by the dynamic forces acting on the crane booms during load movement. When a load is lifted, lowered, or swung, the crane boom experiences varying forces that can induce oscillatory motion. This motion can be exacerbated by sudden changes in load position, environmental factors such as wind, and the inherent flexibility of the crane structure.

Traditionally, hydraulic actuators have been used to control the movement of crane booms. Hydraulic cylinders have many advantages, but hydraulic machinery generally suffers from big energy losses. Hydraulic systems can also struggle with precise control, especially when damping oscillations. Hydraulic systems rely on fluid dynamics, which can introduce delays and inconsistencies in response times, making it challenging to achieve smooth and controlled movements.

Using electrically powered actuators, such as electro-mechanical actuators (EMAs) or electro-hydraulic actuators (EHAs), in working equipment has started to become more and more common. However, the implementation of electro-mechanical actuators in crane systems presents certain challenges, including the damping functions for damping oscillations.

There is thus a need for an improved solution for crane systems with electrically powered actuators, which eliminates the deficiencies and disadvantages with prior art.

### SUMMARY

It is an object of the present disclosure to mitigate, alleviate or eliminate one or more of the above-identified deficiencies and disadvantages in the prior art and solve at least the above-mentioned problem.

It is a further objective of the present invention to achieve a crane arm assembly and a working equipment comprising electro-mechanical actuators, which has an improved way of handling oscillations and thereby allows for higher productivity when operating the crane arm assembly.

According to a first aspect of the present disclosure there is provided a crane arm assembly comprising: a crane arm with at least one boom; and at least one linear electro-mechanical actuator operatively connected to the at least one boom for moving the boom, the at least one electro-mechanical actuator comprising a translation assembly including a rotatable part and a linearly moveable part connected to each other to translate a rotating movement of the rotatable part to a linear movement of the linearly movable part, and a drive assembly arranged to provide the rotating movement of the rotatable part of the translation assembly, the drive assembly comprising an electric motor, wherein the crane arm assembly further comprises: a control system configured to control the drive assembly, wherein the control system is configured to perform an oscillation damping function based on a time-dependent variation of at least one parameter indicating a force acting on the at least one boom, wherein the control system is configured to create a counteracting force reducing the variation of the at least one parameter, by controlling the drive assembly to adjust a drive current to the electric motor.

When a crane arm moves a load, various forces act on the at least one boom. These forces may be from the static weight of the load, but also from additional dynamic loads connected to the dynamics of the load handling. The acceleration and deacceleration during the initiating and final phases of a load movement, environmental factors such as wind, and sudden movements during the load handling are all examples of what may cause dynamic loads to act on the at least one boom as a force.

The forces exerted on the at least one boom can cause it to move or bend, creating stress and strain on the crane structure. This interaction between the forces and the boom's response can lead to oscillations. Oscillations are repetitive movements or vibrations that occur when the at least one boom reacts to the forces. For instance, if a load is abruptly stopped or moved, the at least one boom may swing back and forth, similar to the motion of a pendulum. The magnitude and frequency of these oscillations are directly influenced by the magnitude and nature of the forces acting on the at least one boom. The relationship between the force acting on the at least one boom and the resulting oscillations is critical to the stability and safety of crane operations. Greater forces or more abrupt changes in force can result in more significant oscillations. These oscillations can pose several problems, including uncontrolled movements of the boom, increased wear and tear on the crane components, and potential safety hazards for the operator and the surrounding environment. To address these issues, the crane arm assembly described in the present disclosure includes an oscillation damping function. This function is designed to detect the oscillations caused by the forces acting on the boom. The control system within the crane arm assembly monitors at least one parameter indicative of these forces and the resulting oscillations. Upon detecting oscillations, the control system generates a counteracting force to reduce the oscillations, thereby stabilizing the at least one boom and ensuring smoother and safer movements. Thus, the crane arm assembly according to the present disclosure will ensure an improved stability, safety, precision, durability, and efficiency of the crane arm assembly.

It is to be understood that the oscillation damping function of the crane arm assembly is configured to dampen oscillations caused by a force acting on the at least one boom. The force acting on the at least one boom may be referred to as an external force, a dynamic force or a force caused by a dynamic load. Thus, the present disclosure relates to dampening oscillations caused by for example load variations, environmental factors, interactions with other machinery and movement of the crane arm. Handling oscillations and vibrations caused by forces acting on the at least one boom is significantly different from handling internal oscillations caused by the actuator itself, such as motor torque ripple and electromagnetic fluctuations, and thus requires different actions.

The forces acting on the at least one boom is indicated by the time-dependent variation of the at least one parameter, and the control system controls the drive assembly to generate a counteracting force dampening the oscillation. The control system may continuously monitor the forces acting on the crane booms and adjust the actuator response to dampen oscillations effectively. Different force indicating parameters can be monitored over time, and the change over time will indicate whether there is a force acting on the at least one boom that causes vibrations in the crane arm. The oscillation damping function substantially improves the stability of the crane arm assembly by mitigating oscillations and vibrations caused by the dynamic forces acting on the at least one boom. By reducing oscillations, the damping function minimizes the risk of uncontrolled movements and potential accidents. This is particularly important when handling heavy or delicate loads, ensuring the safety of both the operator and the surrounding environment. The ability to create a counteracting force by means of the electro-mechanical actuator in response to forces allows for more precise control of the crane arm. This precision is crucial for tasks that require accurate positioning and movement of loads, enhancing the overall operational effectiveness. Thus, the use of electro-mechanical actuators can significantly enhance the ability to manage oscillations and vibrations. By means of precise control algorithms, these actuators can create counter forces to mitigate the effects of dynamic loads, ensuring smoother and safer crane operations. The damping function also helps to minimize mechanical stress on the crane components, thereby reducing wear and tear. This leads to an extended lifespan of the equipment, lower maintenance costs, and improved reliability. Also, the crane arm can be slimmer, weaker and of lower weight which is great from a cost, resource efficiency and sustainability perspective. The enhanced stability and precision provided by the oscillation damping function contribute to increased operational efficiency. The crane arm assembly can perform faster and more stable movements, leading to higher productivity and reduced downtime.

The electro-mechanical actuator may comprise a first end part and a second end part, wherein the linearly movable part comprises the second end part. The first end part is typically connected to one part of the crane structure and the second end part is connected to another moveable part of the crane structure. When the rotatable part of the actuator is rotated, the rotating movement is translated into a linear movement of the linearly moveable part and the distance between the first end part and the second end part of the actuator increases or decrease depending on the rotational direction of the rotatable part. This way, the different parts of the crane structure will move in relation to each other. The linearly moveable part may comprise an actuating rod or screw shaft with outer threads. The linearly moveable part is typically received within the rotatable part, which could be a threaded cylinder or similar. Exactly how the translation assembly of an electro-mechanical actuator is configured to translate the rotating movement to a linear movement will not be described herein. It is to be understood that such translation assembly could be configured in many different ways and is not part of the present invention.

According to some examples, the control system comprises a sensor arrangement configured to monitor the at least one parameter and generate an oscillation output signal representing the time-dependent variation of the at least one parameter, wherein the control system further comprises a control unit configured to receive the oscillation output signal and adjust the drive current based on the oscillation output signal to dampen oscillations acting on the boom. The control unit of the control system may thus be configured to control the drive assembly of the electro-mechanical actuator. The sensor arrangement allows for continuous monitoring of the crane's operational parameters, enabling immediate detection and response to oscillations. By generating an oscillation output signal, the control system can quickly adjust the actuator's response to dampen oscillations, improving the stability of the crane arm during load handling.

When using electro-mechanical actuators including electric motors, each motor will be powered by AC power signals (drive current) and power converting units will be required to convert DC power signals to AC power signals. The drive assembly of the electro-mechanical actuator may thus comprise a power converting unit. The power converting unit may also be referred to as an inverter. The control system may thus be configured to control the power converting unit to control the drive current supplied to the electric motor of the actuator. The control system will this way be controlling the output from the actuator in terms of force and displacement. By adjusting the drive current based on input from the time variation of the at least one parameter, the oscillations can be damped and the detected variations in the force will be reduced. The drive assembly of the actuator is preferably connectable to a DC power source via an interface for receiving a DC power signal. The DC power source may be a battery, an accumulator or the electric mains. The battery referred to herein may e.g. be a battery dedicated for the crane arm assembly, a battery located at the working equipment comprising the crane arm assembly, or a battery located at a vehicle, such as a truck, to which the crane arm assembly of the working equipment is mounted. The battery referred to herein may further be a plurality of batteries or battery cells.

There are different ways of monitoring the force acting on the at least one boom, and the at least one parameter could thus comprise various parameters related to the electro-mechanical actuator and/or the at least one boom. All parameters mentioned herein give a good indication of the load, but it is to be understood that the examples mentioned herein are only examples, and there could be other parameters that could be monitored to identify oscillations of the at least one boom.

The at least one parameter may comprise a measured force acting on the at least one boom. Direct measurement of the force acting on the boom ensures precise control and adjustment, enhancing the safety and efficiency of load handling. Accurate force data allows the control system to adjust the drive current in the most optimal way to dampen the oscillations. The control system may comprise at least one force sensor integrated in the actuator or the at least one boom. The force sensor is configured for measuring the force acting on the at least one boom. Such force sensor may be a load cell, a strain gauge, torque transducer or similar.

The at least one parameter may additionally or alternatively comprise the drive current supplied to the electric motor of the electro-mechanical actuator. Torque is the rotational force produced by the electric motor and is related to the drive current by the motor's torque constant. The torque generated by the motor is applied to the translation assembly of the actuator, which translates the rotational movement into linear movement which will pivot the boom. The linear force acting on the at least one boom is thus related to the torque. When forces such as wind or sudden movements cause the boom to oscillate, these forces affect the load on the boom and consequently the drive current required to maintain or adjust the boom's position. Variations in the drive current will thus reflect the dynamic changes in the forces acting on the boom. The control system can use this information to create a counteracting force that mitigates the oscillations, stabilizing the boom and ensuring smoother and safer movements. Thus, by monitoring the drive current supplied to the electric motor, the control system can calculate the torque produced by the motor. Using known geometries of the actuator, the control system can then determine the linear force acting on the boom.

The at least one parameter may additionally or alternatively comprise a displacement of the linearly moveable part of the translation assembly of the electro-mechanical actuator. The electro-mechanical actuator of the crane arm assembly converts the rotational movement of the motor into linear movement of the at least one boom. The displacement of the linearly moveable part of the translation assembly of the actuator is directly related to the force applied by the actuator to move the at least one boom. When a force acts on the boom, it can cause a change in the displacement of the linearly moveable part of the actuator. The relationship between force and displacement is governed by the mechanical properties of the actuator and the boom. According to Hooke's Law, the force (F) acting on the boom is proportional to the displacement (x) of the actuator according to:

F=k·x,
where k is the stiffness constant of the actuator and the boom assembly.

Variations in the displacement indicate changes in the forces acting on the boom. The control system may be configured to continuously monitor the displacement of the linearly moveable part of the actuator and to use this information to detect oscillations and the corresponding forces. By accurately measuring the displacement, the control system can create a counteracting force to mitigate the oscillations, stabilizing the boom and ensuring smoother and safer movements.

The at least one parameter may comprise a pivot angle of the at least one boom. The pivot angle of the boom is the angle between the boom and a reference line, usually the horizontal or vertical axis. When a force acts on the boom, it can cause the boom to pivot, resulting in a change in the pivot angle. The relationship between the force and the pivot angle can be expressed as follows:

F=k·α·r
where k is a constant that depends on the stiffness and mechanical properties of the crane arm assembly, and r is the distance from the pivot point to the point where the force is applied.

By monitoring the variation in the pivot angle, the control system can identify a force acting on the boom. Variations in the pivot angle indicate changes in the forces acting on the boom. The control system may be configured to continuously monitor the pivot angle and to use this information to detect oscillations and the corresponding forces.

Additionally or alternatively, the at least one parameter may comprise a rotation angle of the electric motor and a rotation angle of a gear of the drive assembly. The electro-mechanical actuator comprises at least one gear. The control system may comprise two angle sensors arranged in the electro-mechanical actuator, one at the electric motor and one downstream of the electric motor at the gear. The electric motor generates torque, which is transmitted through the gear to produce linear movement of the boom. The rotation angle of the electric motor and the rotation angle of the gear are directly related to the torque and the resulting force acting on the boom. When a force acts on the boom, it can cause oscillations, leading to variations in these rotation angles. Specifically, the force acting on the at least one boom relates to the difference in rotation angles between the gear and the electric motor, thus to the relative rotation between the gear and the electric motor. The force may be calculated as

F=k2×(Alpha2−Alpha1)
where k2 is a constant that depends on the mechanical properties of the system, such as the stiffness of the gear mechanism and the geometry of the crane arm.

The at least one parameter may additionally or alternatively comprise the position of a tip of the crane arm. The tip position of the crane arm is the endpoint of the crane arm. The tip position of the crane arm may be the endpoint of the at least one boom. The tip position is affected by the forces acting on the at least one boom. When a force acts on the boom, it can cause the boom to bend or oscillate, resulting in a displacement of the tip position. The tip position may be determined by using an angle sensor, such as an inclinometer, to measure the tilt or pivot angle of the crane arm. By knowing the length extension of the crane arm and the pivot angle, the tip position can be calculated. According to some examples, the position of the tip is determined by means of an accelerometer of the control system arranged at the tip. The accelerometer will measure the acceleration of the crane arm tip. By integrating the acceleration, the position of the tip can be determined. Similarly, the at least one parameter may comprise the position of another point of reference at the crane arm or part of the crane arm, thus a point different from the tip of the crane arm.

The control system may comprise an embedded motion profile engine configured to generate motion profiles for the electro-mechanical actuator, wherein the motion profiles are used by the control system to control the drive assembly. This will enable the use of advanced control strategies, improving the efficiency and precision of the oscillation damping function.

The control system may include a feedback loop that continuously monitors the oscillation output signal and adjusts the drive current to maintain the stability of the at least one boom. The feedback loop allows the control system to adapt to changing conditions, ensuring consistent performance This will maintain stability and reduces oscillations, enhancing safety and performance.

The damping function may be activated and/or deactivated manually via a manoeuvring element, or it may be automatically activated and/or deactivated. Having the damping function deactivated will increase operational speed of the crane arm, but this may also lead to oscillations negatively affecting the lifespan of the crane arm assembly. Determining whether the damping function should be activated or not will thus involve balancing operational speed versus lifespan. Typically, the damping function is deactivated during active operation of the crane arm, such as when moving a load. This will ensure efficient movement of the crane arm without unnecessary damping, thereby improving operational speed and efficiency. The control system may be configured to deactivate the damping function during moving operation of the crane arm. Alternatively, the operator of the crane may deactivate the damping function manually via a manoeuvring element such as a lever, button, joystick or similar. The control system may be configured to activate the damping function when the control system receives a signal that a movement of the crane arm is stopped. Thus, the damping function may primarily be used when stopping a movement of the crane arm. The control system may be configured to determine that the movement of the crane arm is about to stop by detecting a deceleration of the movement of the crane arm. The control system may thus be configured to activate the damping function in response to a detected deceleration of the crane arm movement. Alternatively, the control system may be configured to activate the damping function when the time-dependent variation of the at least one parameter indicates a force acting on the at least one boom, which is larger than a predetermined threshold value.

According to some examples, the crane arm comprises a first boom and a second boom and a first and second electro-mechanical actuator arranged to move the respective first and second boom, wherein the control system is configured to perform the oscillation damping function for both electro-mechanical actuators based on a time-dependent variation of at least one parameter indicating a force acting on the respective boom. The crane arm may comprise a jib-system including a first boom and a second boom. The first boom may be connected to a crane column or pillar and the second boom may be connected to the first boom. The control system may thus comprise a sensor arrangement comprising sensors for monitoring the at least one parameter in relation to the first boom and the second boom, and the first and second electro-mechanical actuator. The control system may be configured to analyse the sensor data to detect time-dependent variations and identify oscillations. The control system may further be configured to calculate the necessary counteracting forces to mitigate these oscillations and control the drive assembly accordingly. The control system may be configured to synchronize the adjustment of drive current to both actuators to ensure coordinated operation. By synchronizing the damping function for both actuators, the control system can effectively distribute the load and reduce the impact of oscillations on the crane arm.

Even though the damping function is herein described so as to adjust the drive current to the electric motor of the actuator, it is to be understood that there are multiple ways to implement the oscillation damping function within the control system. There may be several control units, and each method has implications for how the other control unit will operate. As an example, the control system may comprise a position control unit, a speed control unit, and a current control unit. The position control unit focuses on maintaining the desired position of the crane arm. If the damping function is implemented here, the position control unit will adjust the arm's position to counteract any detected oscillations. The adjustments made by the position control unit will influence the speed and current control units downstream. The speed control unit manages the speed at which the crane arm moves. If the damping function is implemented here, the speed control unit will adjust the crane arm's speed to reduce oscillations. The changes in speed will affect the current control unit and ultimately the motor's behaviour. The current control unit regulates the drive current supplied to the electric motor. If the damping function is implemented here, the current control unit will directly adjust the drive current to the motor to dampen oscillations. This method has a direct impact on the motor's performance. By implementing the damping function at different levels (position, speed, or current), the control system can effectively manage oscillations, but each method will have a different impact on the overall system behaviour.

According to a second aspect of the present disclosure, there is provided a working equipment comprising a crane arm assembly according to the first aspect. The working equipment comprises a crane base, a crane column, and the crane arm. The crane column may be rotatable by means of an electrically powered actuator.

The working equipment may for example be a loader crane which may be used for various applications. The working equipment may further comprise working tools to e.g. pick up objects and hence be used in the work performed with the working equipment. The working tool may be mounted to an end of the crane arm. Examples of such working tools include grapples, clamshell buckets, buckets, brick grabs and grips. The working equipment may comprise an electrically powered actuator configured to operate the movements of the working tool to interact with objects or material to be picked up, harvested, collected etc. The working equipment may further comprise extendable stabilizer legs operated by electrically powered actuators.

The working equipment may be configured to be arranged on a vehicle. The vehicle may be an electric driven vehicle. The vehicle may be propelled by a combustion engine. The vehicle may be an autonomous vehicle, or a semi-autonomous vehicle. The vehicle may be a lorry or a truck.

The effects and features of the second aspect are to a large extent analogous to those described above in connection with the first aspect. Examples mentioned in relation to the first aspect are largely compatible with the second aspect.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 schematically illustrates a crane arm assembly according to an example of the present disclosure.

FIG. 2 schematically illustrates the electro-mechanical actuator according to an example of the present disclosure.

FIG. 3 schematically illustrates the control system of the crane arm assembly according to examples of the present disclosure.

FIG. 4 schematically illustrates a vehicle with a working equipment according to an example of the present disclosure.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

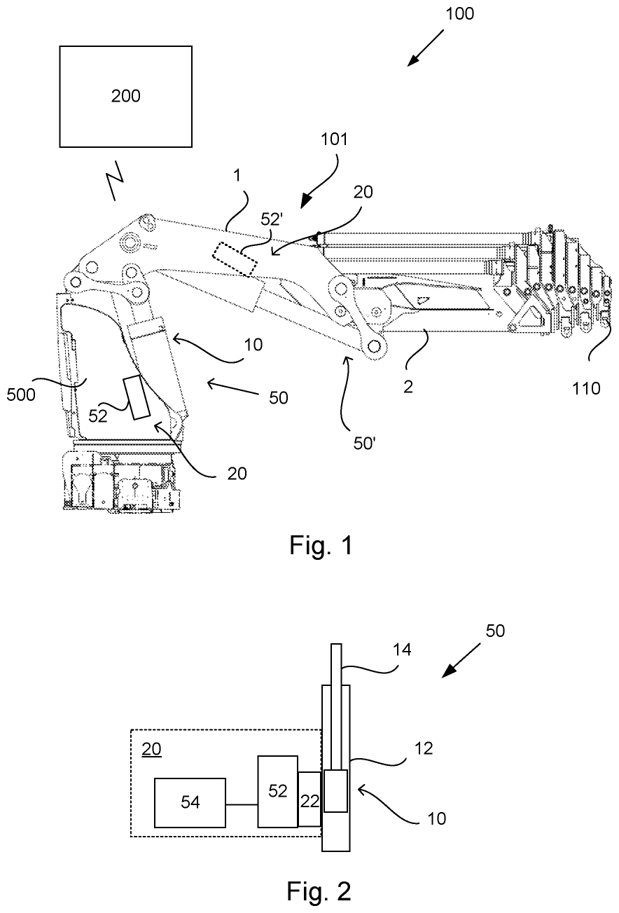

FIG. 1 schematically illustrates a crane arm assembly 100 according to an example of the present disclosure. The crane arm assembly 100 comprises a crane arm 101 with a first boom 1. The first boom 1 may be connectable to a crane column 500. This example further includes a second boom 2, but it is to be understood that the crane arm 101 can comprise any number of booms, such as a third and fourth boom. The booms referred to herein may further comprise a single boom section or be of the type telescopic booms, comprising a plurality of telescopically retractable and/or extendable boom sections. The crane arm 101 has a tip 110, also referred to as the endpoint of the crane arm 101. The crane arm assembly 100 further comprises a first linear electro-mechanical actuator 50 operatively connected to the first boom 1 for moving the first boom 1. The first actuator 50 is connected between the first boom 1 and the crane column 500 and is thus configured to move the first boom 1 in relation to the crane column 500. The crane arm assembly 100 also comprises a second electro-mechanical actuator 50′ operatively connected to the second boom 2. The second actuator 50′ is connected between the first boom 1 and the second boom 2 and is thus configured to move the second boom 2 in relation to the first boom 1.

The first and second actuator 50, 50′ each comprises a translation assembly 10 configured to translate a rotating movement to a linear movement and a drive assembly 20 configured to provide the rotating movement. The drive assembly 20 of each actuator 50, 50′ comprises an electric motor 52, 52′. The actuator 50 is further described in relation to FIG. 2.

The crane arm assembly 100 further comprises a control system 200 configured to control the drive assembly 20 of each actuator 50, 50′. The control system 200 is further configured to perform an oscillation damping function in relation to each actuator 50, 50′ based on a time-dependent variation of at least one parameter indicating a force acting on the respective boom 1, 2. The oscillation damping function involves creating a counteracting force for reducing the variation of the at least one parameter. The counteracting force is created by controlling the drive assembly 20 of the respective actuator 50, 50′ to adjust a drive current supplied to the electric motor 52, 52′. The control system 200 may be configured to synchronize the damping function for both actuators 50, 50′ or the control system 200 may be configured to perform the damping function in relation to the respective actuator 50, 50′ individually, irrespective of each other.

FIG. 2 schematically illustrates an electro-mechanical actuator 50 according to an example of the present disclosure. The actuator 50 forms part of the crane arm assembly 100 as disclosed in FIG. 1.

The actuator 50 thus comprises a translation assembly 10 and a drive assembly 20. The translation assembly 10 comprises a rotatable part 12 and a linearly moveable part 14 connected to each other to translate a rotating movement of the rotatable part 12 to a linear movement of the linearly movable part 14. The drive assembly 20 comprises an electric motor 52 configured to provide the rotating movement of the rotatable part 12 of the translation assembly 10. The electric motor 52 is powered by an alternating drive current (AC) and the drive assembly 20 therefore comprises a power converting unit 54 configured to convert direct current (DC) to alternating current. The power converting unit 54 may also be referred to as an inverter. The control system 200 of the crane arm assembly 100 as described in FIG. 1 may be configured to control the power converting unit 54 to control the drive current supplied to the electric motor 52 of the actuator 50. The control system 200 will this way be controlling the output from the actuator 50 in terms of force and displacement. The drive assembly 20 of the actuator 50 is suitably connectable to an interface for receiving a DC power signal from a DC power source.

The actuator 50 typically also comprises at least one gear 22 connected to the electric motor 52 for transmitting motion and force from the electric motor 52 to the translation assembly 10.

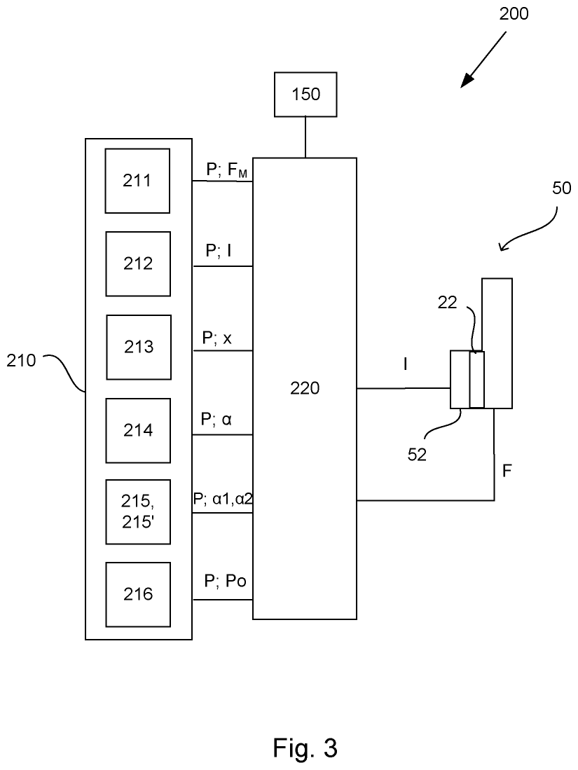

FIG. 3 schematically illustrates the control system 200 of a crane arm assembly according to examples of the present disclosure. The control system 200 forms part of a crane arm assembly 100 as disclosed in FIG. 1.

The control system 200 is configured to perform an oscillation damping function in relation to at least one electro-mechanical actuator 50 based on a time-dependent variation of at least one parameter P indicating a force acting on the boom moved by the actuator 50. The control system 200 is configured to create a counteracting force reducing the variation of the at least one parameter P. The counteracting force is typically created by controlling the drive assembly 20 of the actuator 50 to adjust a drive current I supplied to the electric motor 52 of the actuator 50.

The control system 200 comprises a sensor arrangement 210 configured to monitor the at least one parameter P and generate an oscillation output signal representing the time-dependent variation of the at least one parameter P. The control system 200 further comprises a control unit 220 configured to receive the oscillation output signal and adjust the drive current I based on the oscillation output signal to dampen oscillations acting on the boom. The oscillation output signal from the sensor arrangement 210 thus relates to the parameter being monitored in order to identify a force acting the boom and causing oscillations. The sensor arrangement 210 may comprise at least one sensor unit 211-216 arranged in relation to the actuator 50 and/or the boom. The at least one sensor unit 211-216 is configured to monitor the at least one parameter P.

The sensor arrangement 210 may comprise a force sensor 211 arranged to measure a force FM acting on the boom. The at least one parameter P may thus be a measured force FM acting on the boom. The force sensor 211 may be integrated in the actuator 50 or the boom. The force sensor 211 may be a load cell, a strain gauge, torque transducer or similar.

The sensor arrangement 210 may comprise a current sensor 212 arranged to measure the drive current I supplied to the electric motor 52 of the actuator 50. The at least one parameter P may thus comprise the drive current I supplied to the electric motor 52. Variations in the drive current I will reflect the dynamic changes in the forces acting on the boom. The control unit 220 can use this information to create a counteracting force that mitigates the oscillations, stabilizing the boom and ensuring smoother and safer movements.

The sensor arrangement 210 may comprise displacement sensor 213 arranged to measure the displacement x of the linearly moveable part of the actuator 50. The at least one parameter P may thus comprise a displacement x of the linearly moveable part of the actuator 50. The displacement x of the linearly moveable part is directly related to the force F applied by the actuator 50 to move the boom. Variations in the displacement x indicate changes in the forces acting on the boom.

The sensor arrangement 210 may comprise a first angle sensor 214 arranged to measure a pivot angle α of the boom. The at least one parameter P may thus comprise a pivot angle α of the boom. The pivot angle α of the boom is the angle between the boom and a reference line, usually the horizontal or vertical axis. When a force acts on the boom, it can cause the boom to pivot, resulting in a change in the pivot angle α. Variations in the pivot angle α indicate changes in the forces acting on the boom.

The sensor arrangement 210 may comprise a second and third angle sensor 215, 215′ arranged to measure a rotation angle α1 of the electric motor 52 of the actuator 50 respectively a rotation angle α2 of the gear 22 of the actuator 50. The at least one parameter P may thus comprise a rotation angle α1 of the electric motor 52 and a rotation angle α2 of a gear 22 of the actuator 50. The rotation angle α1 of the electric motor 52 and the rotation angle α2 of the gear 22 are directly related to the torque and the resulting force acting on the boom.

The sensor arrangement 210 may comprise a sensor unit 216 arranged to determine the position Po of the crane arm tip 110. The at least one parameter P may thus comprise the position Po of the tip of the crane arm. The tip position Po is affected by the forces acting on the boom. The sensor unit 216 may be an angle, such as an inclinometer, configured to measure the tilt or pivot angle of the crane arm. Alternatively, the sensor unit 216 is an accelerometer arranged at the crane arm tip. By integrating the acceleration, the position Po of the tip can be determined. In a similar manner, and as an alternative or addition, the sensor arrangement 210 may comprise a sensor unit 216 arranged to determine the position of another point of the crane arm. This may be another point than the crane arm tip 110.

The damping function may be activated and/or deactivated manually via a manoeuvring element 150, or it can be automatically activated and/or deactivated by the control system 200. The manoeuvring element 150 may comprise a button, a lever, a menu selection or similar. The control system 200 may be configured to activate the damping function when the control system 200 receives a signal that a movement of the crane arm is stopped. This signal may come from the operator releasing a manoeuvring unit to stop a corresponding movement or the operator decreasing the movement speed of the manoeuvring unit, or the signal may come from the sensor arrangement 210 detecting a deceleration of the crane arm movement. The control system 200 may be configured to deactivate the damping function during moving operation of the crane arm.

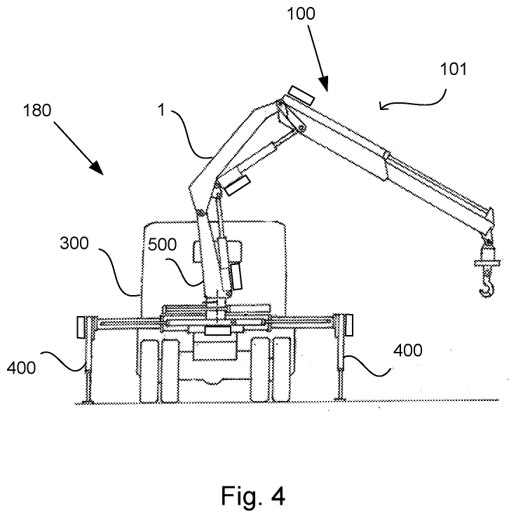

FIG. 4 schematically illustrates a vehicle with a working equipment 180 according to an example of the present disclosure. The working equipment 180 is a loader crane and comprises a crane arm assembly 100 as disclosed in FIG. 1. The working equipment 180 comprises a rotatable crane column 500 forming part of the crane structure supporting the crane arm 101. The crane column 500 may be rotated by electrically powered actuators. The working equipment 180 further comprises extendable stabilizer legs 400 operated by electrically powered actuators. The working equipment 180 is arranged on a vehicle 300.

The person skilled in the art realizes that the present disclosure is not limited to the preferred embodiments described above. The person skilled in the art further realizes that modifications and variations are possible within the scope of the appended claims.

1. A crane arm assembly (100) comprising:
a crane arm (101) with at least one boom (1); and
at least one linear electro-mechanical actuator (50) operatively connected to the at least one boom (1) for moving the boom (1), the at least one electro-mechanical actuator (50) comprising a translation assembly (10) including a rotatable part (12) and a linearly moveable part (14) connected to each other to translate a rotating movement of the rotatable part (12) to a linear movement of the linearly movable part (14), and a drive assembly (20) arranged to provide the rotating movement of the rotatable part (12) of the translation assembly (10), the drive assembly (20) comprising an electric motor (52),
wherein the crane arm assembly (100) further comprises:
a control system (200) configured to control the drive assembly (20), wherein the control system (200) is configured to perform an oscillation damping function based on a time-dependent variation of at least one parameter (P) indicating a force acting on the at least one boom (1), wherein the control system (200) is configured to create a counteracting force reducing the variation of the at least one parameter (P), by controlling the drive assembly (20) to adjust a drive current (I) to the electric motor (52).

2. The crane arm assembly (100) according to claim 1, wherein the control system (200) comprises a sensor arrangement (210) configured to monitor the at least one parameter (P) and generate an oscillation output signal representing the time-dependent variation of the at least one parameter (P), wherein the control system (200) further comprises a control unit (220) configured to receive the oscillation output signal and adjust the drive current (I) based on the oscillation output signal to dampen oscillations acting on the boom (1).

3. The crane arm assembly (100) according to claim 1, wherein the at least one parameter (P) comprises a measured force (F_{M}) acting on the at least one boom (1).

4. The crane arm assembly (100) according to claim 1, wherein the at least one parameter (P) comprises the drive current (I) supplied to the electric motor (52) of the electro-mechanical actuator (50).

5. The crane arm assembly (100) according to claim 1, wherein the at least one parameter (P) comprises a displacement (x) of the linearly moveable part (14) of the translation assembly (10) of the electro-mechanical actuator (50).

6. The crane arm assembly (100) according to claim 1, wherein the at least one parameter (P) comprises a pivot angle (α) of the at least one boom (1).

7. The crane arm assembly (100) according to claim 1, wherein the at least one parameter (P) comprises a rotation angle (α1) of the electric motor (52) and a rotation angle (α2) of a gear (22) of the drive assembly (20).

8. The crane arm assembly (100) according to claim 1, wherein the at least one parameter (P) comprises the position (Po) of a tip (110) of the crane arm (101).

9. The crane arm assembly (100) according to claim 8, wherein the position (Po) of the tip (110) is determined by means of an accelerometer (216) of the control system (200) arranged at the tip (110).

10. The crane arm assembly (100) according to claim 1, wherein the control system (200) comprises an embedded motion profile engine configured to generate motion profiles for the electro-mechanical actuator (50), wherein the motion profiles are used by the control system (200) to control the drive assembly (20).

11. The crane arm assembly (100) according to claim 2, wherein the control system (200) includes a feedback loop that continuously monitors the oscillation output signal and adjusts the drive current (I) to maintain the stability of the at least one boom (1).

12. The crane arm assembly (100) according to claim 1, wherein the damping function is activated and/or deactivated manually via a manoeuvring element (150), or it is automatically activated and/or deactivated.

13. The crane arm assembly (100) according to claim 1, wherein the control system (200) is configured to activate the damping function when the control system (200) receives a signal that a movement of the crane arm (101) is stopped.

14. The crane arm assembly (100) according to claim 1, wherein the control system (200) is configured to deactivate the damping function during moving operation of the crane arm (101).

15. The crane arm assembly (100) according to claim 1, comprising a first boom (1) and a second boom (2) and a first and second electro-mechanical actuator (50, 50′) arranged to move the respective first and second boom (1, 2), wherein the control system (200) is configured to perform the oscillation damping function for both electro-mechanical actuators (50, 50′) based on a time-dependent variation of at least one parameter indicating a force acting on the respective boom (1,2).

16. A working equipment (180) comprising a crane arm assembly (100) according to claim 1.

17. The working equipment (180) according to claim 16, wherein the working equipment (180) is configured to be arranged on a vehicle (300).
